(19) United States
(12) Patent Application Publication
(10) Pub. No.: US 2005/0064845 A1
(43) Pub. Date: Mar. 24, 2005

(54) System and method for radius accounting for wireless communication networks

(75) Inventors: Stephen K. Clingerman, McKinney, TX (US); Prasanna J. Satarasinghe, McKinney, TX (US); Yoon Hee Kim, Coppell, TX (US); David Ka-Wai Hui, Fremont, CA (US); Harpal Singh Narula, Carrollton, TX (US); Abid Inam, Grapevine, TX (US)

Correspondence Address: HAYNES AND BOONE, LLP, 901 MAIN STREET, SUITE 3100, DALLAS, TX, 75202, US

(73) Assignee: Transat Technologies, Inc., Southlake, TX (US)

(21) Appl. No.: 10/668,122

(22) Filed: Sep. 23, 2003

(51) Int. Cl. H04M 11/00

(52) U.S. Cl. 455/408

(57) ABSTRACT

An authentication server includes a first link connected to an authenticator associated with a Wireless Local Area Network (WLAN) and a second link connected to a gateway associated with a mobile network such as a GPRS network. The authentication server also includes a mapping system having instructions for receiving one or more first messages from the authenticator, the first messages being of a first type associated with the WLAN but not the mobile network, such as a RADIUS message. The mapping system also includes instructions for generating a first group of one or more call detail records from the received first messages, the call detail records being of a second type associated with the mobile network, and sending the first group of call detail records to the gateway.

### RELATED APPLICATION

This application relates to U.S. application Ser. No. 09/851,681, filed on May 8, 2001, which is commonly assigned and incorporated herein by reference in its entirety.

### BACKGROUND OF THE INVENTION

The present invention relates generally to a communications system and, more particularly, to a method and apparatus for billing and/or accounting for users across wireless communication networks using a remote authentication protocol.

There exists several different accounting methods that users may utilize to access a wireless communications networks However, no efficient method or system exists that provides accounting for Subscriber Identity Module (SIM) users across wireless communication network using a protocol such as the Remote Authentication Dial-In User Service (RADIUS) protocol.

Therefore, what is needed, is a system and method that provides accounting for SIM users across wireless communication network using the RADIUS protocol.

### SUMMARY OF THE INVENTION

The present invention describes a system and method that provides accounting for mobile users across wireless communication network using a remote authentication protocol such as the RADIUS protocol. In one embodiment, the system includes an access point connectable to a mobile client and a wireless integrated node connected to the access point and configured for providing and mapping between two different communication protocols. The system also includes a link for connecting the wireless integrated node to a charging gateway and further to an accounting system, such as one associated with a General Packet Radio Service (GPRS) network. The accounting system provides a bill for usage of the wireless network by the mobile client. The first communication protocol is of a format required by the wireless network and the second communication protocol is of a format required by the accounting system.

In another embodiment, a method is provided for generating call detail records in a format used with a mobile network, such as a GPRS network, for a client having an account with the mobile network and using a wireless local area network. The method includes receiving a RADIUS message, such as a start, interim, or stop message, from an access point. A Call Detail Record (CDR) is generated from accounting information contained in the RADIUS message and sent to a charging gateway associated with the mobile network.

In another embodiment, an authentication server is provided. The authentication server includes a first link connected to an authenticator associated with a Wireless Local Area Network (WLAN) and a second link connected to a gateway associated with a mobile network such as a GPRS network. The authentication server also includes a mapping system having instructions for receiving one or more first messages from the authenticator, the first messages being of a first type associated with the WLAN but not the mobile network, such as a RADIUS message. The mapping system also includes instructions for generating a first group of one or more call detail records from the received first messages, the call detail records being of a second type associated with the mobile network, and sending the first group of call detail records to the gateway.

Therefore, in accordance with the previous summary, objects, features and advantages of the present disclosure will become apparent to one skilled in the art from the subsequent description and the appended claims taken in conjunction with the accompanying drawings.

### BRIEF DESCRIPTION OF THE DRAWINGS

FIG. 1 depicts a message dialog of a wireless unit logging into a RADIUS server.

FIG. 2 depicts an exemplary simplified telecommunications network and system that can benefit from the present invention.

FIG. 3 depicts a message sequence diagram showing the call detail record (CDR) generation triggers and transmission of CDRs.

### DETAILED DESCRIPTION

The present invention can be described by the embodiments given below. It is understood, however, that the embodiments below are not necessarily limitations to the present invention, but are used to describe a typical implementation of the invention. In addition, details of a Wireless Access Integrated Node (WAIN) server and architecture can be found in the patent application Ser. No. 09/851,681, incorporated by reference above.

There are at least two different accounting standards supported by wireless data service providers. The General Packet Radio Service (GPRS) operators currently comply with European Telecommunications Standard Institute (ETSI) standards while the Wireless Internet Service Provider (WISP) operators comply with Internet Engineering Task Force (IETF) standards. In addition, ETSI accounting methods utilize the user's International Mobile Subscriber Identity (IMSI) within a SIM card to identify accounting records while IETF accounting methods use a User ID field to identify accounting records. Moreover, ETSI accounting utilizes Call Detail Records (CDRs) while IETF accounting does not. There are also other differences between each accounting method's parameters. Wireless Local Area Network (WLAN) users can have a GPRS subscription associated with their IMSI or have a WLAN-only subscription associated with an User ID and a password. Currently, the WLAN users with IMSIs utilize ETSI accounting standards while the WLAN users without an IMSI utilize the IETF accounting standards.

However, some situations exist where a combination of the two accounting methods is required. For example, a user with an IMSI (GPRS subscription) may need to use the RADIUS protocol that is usually associated with IETF accounting, but may also desire to use ETSI accounting by the service provider. Nonetheless, no current method exists to create such a combined accounting structure.

The present disclosure solves this dilemma by using the RADIUS accounting records and mapping them to the GPRS CDRs. The present disclosure also creates different triggering events to create the CDRs that do not otherwise exist in traditional GPRS accounting methods.

One example scenario where RADIUS can be used with GPRS CDRs is when IEEE 802.1x and EAP are used in conjunction with RADIUS for a user that has a GPRS subscription. The terms PPP, EAP and IEEE 802.1x are described in further detail below.

Point-to-Point Protocol (PPP) is most commonly used for dial-up Internet access. PPP is also used by some ISPs for DSL and cable modem authentication, in the form of PPP over Ethernet. PPP is part of a Layer 2 Tunneling Protocol of the Open System Interconnect (OSI) 7 layer protocol model.

PPP evolved beyond its original use as a dial-up access method and is now used all over the Internet. One aspect of PPP defines an authentication mechanism, such as a username and password with dial-up Internet access. PPP authentication can be used to identify the user for purposes of granting access.

Some enterprises want to do more for security than simply employing usernames and passwords for access, so a new authentication protocol, called the Extensible Authentication Protocol (EAP), was designed. EAP resides inside of PPP's authentication protocol and provides a generalized framework for several different authentication methods. EAP was designed to let authentication methods such as passwords to challenge-response tokens and public-key infrastructure certificates to work smoothly.

With a standardized EAP, interoperability and compatibility of authentication methods become simpler. For example, when a user dial a remote-access server and uses EAP as part of the PPP connection, the Remote Access Server (RAS) does not need to know any of the details about the authentication system. Only the user and the authentication server have to be coordinated. By supporting EAP authentication, a RAS gets out of the business of acting as middle man, and just packages and repackages EAP packets to hand off to a RADIUS server that will do the actual authentication.

The IEEE 802.1x standard is often used for passing EAP over a wired or wireless LAN. With 802.1x, the EAP messages are packaged in Ethernet frames and do not use PPP. 802.1x is authentication and nothing more. This may be desirable in situations in which the rest of PPP is not needed, where protocols other than TCP/IP are being used, or where the overhead and complexity of using PPP is undesirable.

In 802.1x, the user or client that wants to be authenticated is often called a supplicant. The actual server doing the authentication, typically a RADIUS server, is often called the authentication server. The device in between, such as a wireless access point, is often called the authenticator. One of the key points of 802.1x is that the authenticator can be simple and dumb, i.e., it has limited, if any, processing software. Instead, the brains are in the supplicant and the authentication server. This makes 802.1x ideal for wireless access points, which are typically small and have little memory and processing power.

The protocol in 802.1x is called EAP encapsulation over LANs (EAPOL). It is currently defined for Ethernet-like LANs including 802.11 wireless, as well as token ring LANs such as FDDI. There are a number of modes of operation. An exemplary mode of operation is described in the next few paragraphs.

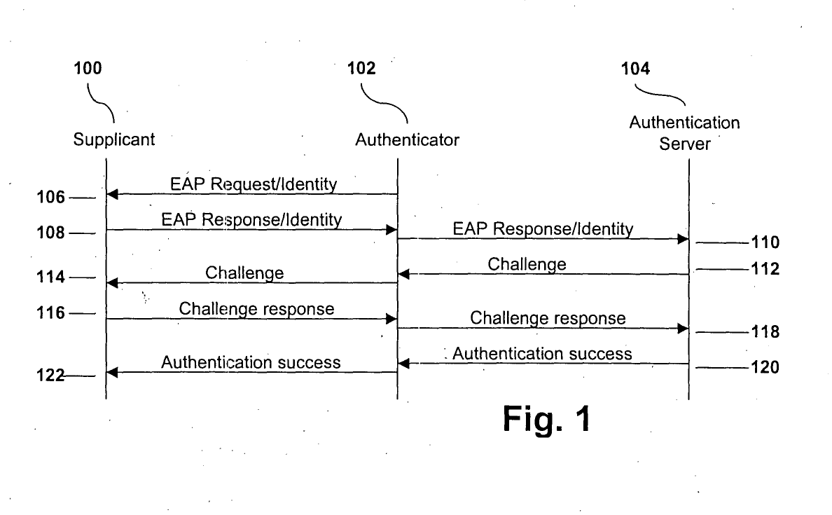

Referring to FIG. 1, in one embodiment, an authenticator 100, a supplicant 102, and an authentication server 104 are connectable via appropriate links. The authenticator 100 sends an “EAP-Request/Identity” message 106 to the supplicant 102 as soon as it detects that a link is active (e.g., the supplicant system has associated with the access point). The supplicant 102 then sends the authenticator 100 an “EAP-Response/Identity” message 108, which is then passed on to an authentication (RADIUS) server 104 as a “EAP-Response/Identity” message 110.

The authentication server 104 sends the authenticator 100 a challenge message 112, which may employ a token password system. The authenticator 100 unpacks the challenge message 112 from IP, repackages the challenge message into EAPOL, and sends a challenge message 114 to the supplicant 102. However, different authentication methods will vary this message and the total number of messages. EAP supports client-only authentication and strong mutual authentication. Strong mutual authentication is usually considered appropriate for the wireless case.

The supplicant 100 responds to the challenge message 114 received from the authenticator 102 with a challenge response message 116. The authenticator 102 passes the challenge response message 116 on to the authentication server 104 in a challenge response message 118. If the supplicant 100 provides proper identity, the authentication server 104 responds by sending a success message 120 to the authenticator 102. The authenticator 102 forwards this message on to the supplicant 100 as an authentication success message 122. The authenticator 100 now allows access to the LAN—possibly restricted based on attributes that came back from the authentication server 104. For example, the authenticator 102 might switch the supplicant 100 to a particular virtual LAN or install a set of firewall rules.

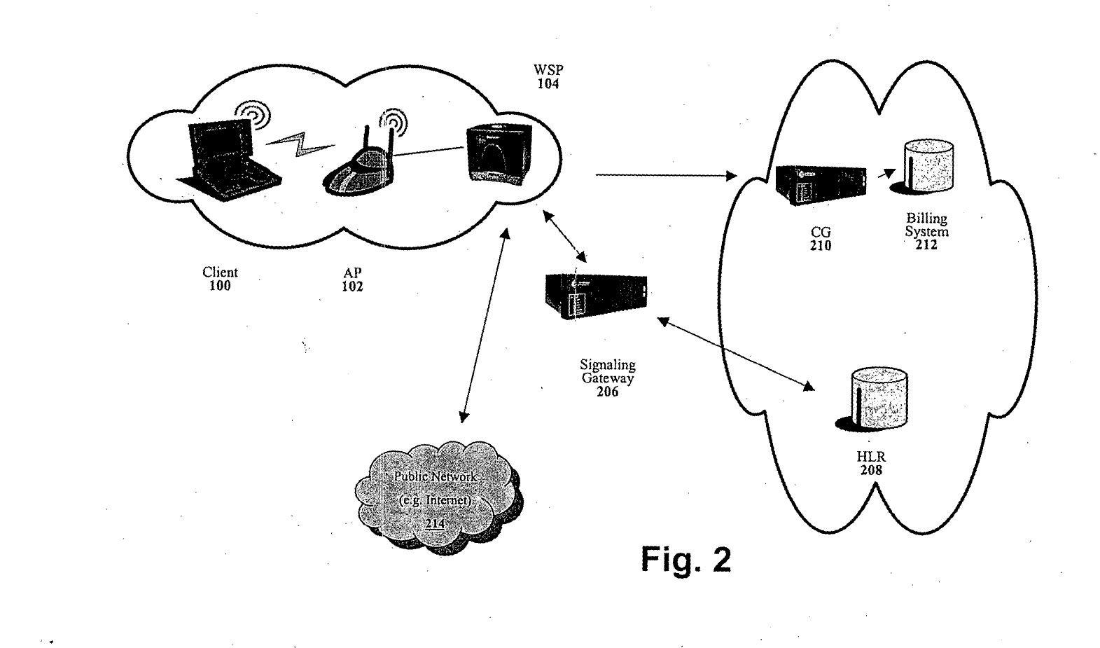

Referring to FIG. 2, in an exemplary simplified telecommunications network, the intelligent mobile device client (supplicant) 100 is in wireless communication with the authenticator/wireless access point (AP) 102. The AP 102 is in wireline communication with an authentication server or Wireless Services Platform (WSP) 104. One example of a WSP is the WAIN server provided by Transat Technologies, Inc. of Southlake, Tex. The WSP 104 includes one or more memory devices for storing instructions and data files, and one or more processing devices for acting on the instructions and data file, as described in greater detail below. The WSP 104 also includes various interfaces to communicate with other nodes through wired and wireless links. It is understood that the diagram of FIG. 2 is simplified, and many additional and/or different nodes are likely to exist and many additional and/or different links may be used between the various nodes.

The WSP 104 is in communication with a Signaling Gateway 206 which is in communication with a Home Location Register 208. The WSP 104 is in communication with a Charging Gateway 210 which is in communication with a Billing System 212. The WSP 104 is in communication with a public network 214 which may be the Internet and provides access to the intelligent mobile device client 100 to the public network 214. In the present invention, the WSP 104 provides RADIUS Server services among its other services.

When the client (supplicant) 100 has access to the GPRS network, accounting records need to be kept for this client. As stated earlier, one embodiment of the present invention provides a combined accounting method for SIM users that traditionally use GPRS accounting, but are using RADIUS messaging. One method to accomplish a combined accounting method is to map RADIUS accounting parameters to a GPRS call detail record.

GSM Call Detail Records

ETSI accounting complies with Global System for Mobile Communication (GSM) specification 12.15 which utilize Call Detail Records (CDRs). These CDRs are generated upon reaching certain trigger conditions specified by the GSM 12.15. Moreover, the IMSI is a user identifier that links the CDR to a particular user. Two types of CDRs are generated, an S-CDR and a G-CDR. The CDR contents are shown in Table 1.

TABLE 1
GPRS CDR Format

| | Presence | |
|---|---|---|
| | M = Mandatory | |
| | C = Conditional | |
| Field | O = Optional | Description |
| Record Type | M (S-CDR/G- | The field identifies the type of the record e.g. S-CDR, G- |
| | CDR | CDR, M-CDR, S-SMO-CDR and S-SMT-CDR. |
| Network | C (S-CDR/G- | This field indicates that Packet Data Protocol (PDP) |
| Initiated PDP | CDR) | context is network initiated. The field is missing in case of |
| Context | | mobile activated PDP context. |
| Anonymous | C (S-CDR/G- | Set to true to indicate anonymous access (and that the |
| Access | CDR) | Served IMSI is not supplied) |
| Indicator | | |
| Served IMSI | M (S-CDR/G- | This field contains the international mobile subscriber |
| | CDR) | identity (IMSI) of the served party. The Client “served” |
| | | party is used to describe the mobile subscriber involved in |
| | | the transaction recorded (e.g. the calling subscriber in case |
| | | of a mobile initiated PDP context.) The structure of the |
| | | IMSI is defined in GSM 03.03. |
| Served IMEI | C (S-CDR/G- | This field contains the international mobile equipment |
| | CDR) | identity (IMEI) of the equipment served. The Client |
| | | “served” equipment is used to describe the ME involved in |
| | | the transaction recorded (e.g. the called ME in the case of |
| | | a network initiated PDP context.) The structure of the |
| | | IMEI is defined in GSM 03.03. |
| SGSN | M (S-CDR/G- | The S-CDR fields contain the single address of current |
| Address | CDR) | Serving GPRS Serving Node (SGSN) and GGSN used. |
| GGSN | M (S-CDR/G- | The IP address of the Gateway GPRS Support Node |
| Address | CDR) | (GGSN) used. |
| MS Network | | This MS Network Capability field contains the MS |
| Capability | | network capability value of the MS network capability |
| | | information element of the served MS on PDP context |
| | | activation or on GPRS attachment as defined in GSM |
| | | 04.08. |
| Routing Area | | Routing Area at the time of the record creation. |
| Local Area | | Location area code at the time of the record creation. |
| Code | | |
| Cell Identity | | Cell ID at the time of the record creation. |
| Charging ID | M (S-CDR/G- | This field is a charging identifier which can be used |
| | CDR) | together with the GGSN address to identify all records |
| | | produced in SGSN(s) and GGSN involved in a single PDP |
| | | context. Charging ID is generated by the GGSN at PDP |
| | | context activation and transferred to the context requesting |
| | | SGSN. At inter-SGSN routing area update, charging ID is |
| | | transferred to the new SGSN as part of each active PDP |
| | | context. Different GGSNs allocate the charging ID |
| | | independently of each other and may allocate the same |
| | | numbers. The Charging Gateway Facility (CGF) and/or |
| | | BS may check the uniqueness of each charging ID together |
| | | with the GGSN address and optionally (if still |
| | | unambiguous) with the record opening time stamp. The |
| | | GGSN function in the WS generates an integer in the range |
| | | of 0 . . . 4294967295 unique to itself for every CDR issued. |
| GGSN | M (S-CDR) | The IP address of the GGSN currently used. The GGSN |
| Address | | address is always the same for an activated PDP. |
| Used | | |
| Access Point | M (S-CDR/G- | This field contains the logical Access Point Name (APN) |
| Name NI | CDR) | used to determine the actual connected access point. The |
| | | APN is comprised of a mandatory network identifier and |
| | | an optional operator identifier (this field is the network |
| | | identifier). The APN can also be a wildcard, in which case |
| | | the SGSN selects the access point address. See GSM |
| | | 09.60 and GSM 03.60 for more information about APN |
| | | format and access point decision rules. The APN is |
| | | information from the MS or SGSN, that may be used by |
| | | the GGSN to differentiate between accesses to different |
| | | external packet data networks using the same PDP Type. |
| APN | O (S-CDR/G- | This field indicates how the SGSN selected the APN to be |
| Selection | CDR) | used. The values and their meaning are as specified in |
| Mode | | GSM 09.60 clause 7.9 ‘Information elements’. |
| PDP Type | M (S-CDR/G- | This field defines the PDP type (e.g. X.25, IP, PPP, or |
| | CDR) | IHOSS:OSP) (see GSM 09.60 for exact format). |
| Served PDP | M (S-CDR/G- | This field contains the PDP address of the served IMSI. |
| Address | CDR) | This is a network layer address (e.g. of type IP version 4, |
| | | IP version 6 or X.121). The address for each PDP type is |
| | | allocated either temporarily or permanently (see field |
| | | “Dynamic Address Flag”) |
| Remote PDP | O (G-CDR) | Remote PDP address may be used if PDP type is X.25. |
| Address | | This parameter is not used if the PDP type is IP, PPP, or |
| | | IHOSS:OSP. Itemized volume billing is available per |
| | | APN. This field contains a list of connected remote PDP |
| | | addresses. |
| Dynamic | C (G-CDR) | This field indicates that PDP address has been dynamically |
| Address Flag | | allocated for that particular PDP context. Field is missing |
| | | if address is static (e.g. part of PDP context subscription). |
| | | Dynamic address allocation might be relevant for charging |
| | | (e.g. the duration of PDP context as one resource offered |
| | | and possible owned by network operator). |
| List of | M (S-CDR/G- | This list includes one or more containers, which each |
| Traffic Data | CDR) | include the following fields: Data Volume Uplink, Data |
| Volumes | | Volume Downlink, Change Condition and Time Stamp. |
| | | Data Volume includes the number of octets transmitted |
| | | during the use of packet data services. Change condition |
| | | defines the reason for closing the container (see 5.7.1 and |
| | | 5.7.3), such as tariff time change, Quality of Service (QoS) |
| | | change or closing the CDR. Change time is a time stamp |
| | | which defines the moment when the new volume counts |
| | | are started or the CDR is closed. All the active PDP |
| | | contexts do not need to have exactly the same time stamp |
| | | (e.g. due to same tariff time change variance of the time |
| | | stamps is implementation and traffic load dependent and is |
| | | out of the scope of standardization). The first container |
| | | can include the following optional fields: QoS Requested |
| | | (not in G-CDR) and QoS Negotiated. In the containers |
| | | that follow, QoS Negotiated is present if previous change |
| | | condition is QoS change. For more information, see 12.15 |
| | | page 28. |
| Record | M (S-CDR/G- | This field contains the time stamp of when the record is |
| Opening | CDR) | opened (see GSM 12.05 for exact format). Record opening |
| Time | | reason does not have a separate field. For G-CDR and M- |
| | | CDR, it can be derived from the field “Sequence number” |
| | | i.e. missing field or value one means activation of PDP |
| | | context and GPRS attachment. For the S-CDR, the field |
| | | “SGSN change” also needs to be taken into account. |
| Duration | M (S-CDR/G- | This field contains the relevant duration in seconds for |
| | CDR) | PDP contexts (S-CDR, G-CDR, and attachment (M- |
| | | CDR)). For partial records, this is the duration of the |
| | | individual partial record and not the cumulative duration. |
| | | It should be noted that the internal time measurements may |
| | | be expressed in terms of tenths of seconds or even |
| | | milliseconds and, as a result, the calculation of the duration |
| | | may result in the rounding or truncation of the measured |
| | | duration to a whole number of seconds. Whether or not |
| | | rounding or truncation is to be used is considered to be |
| | | outside the scope of this Specification subject to the |
| | | following restrictions: A duration of zero seconds shall be |
| | | accepted providing that the transferred data volume is |
| | | greater than zero. The same method of |
| | | truncation/rounding shall be applied to both single and |
| | | partial records. |
| SGSN | C (S-CDR) | This field is present only in the S-CDR to indicate that this |
| Change | | is the first record after an inter-SGSN routing area update. |
| Cause for | M (S-CDR/G- | This field contains a reason for the release of the CDR |
| Record | CDR) | including the following: normal release - PDP context |
| Closing | | release or GPRS detach; partial record generation - data |
| | | volume limit, time (duration) limit, SGSN change of |
| | | maximum number of changes in charging conditions; |
| | | abnormal termination (PDP or MM context); and |
| | | management intervention (request due to O&M reasons). |
| | | A more detailed reason may be found in the diagnostics |
| | | field. |
| Diagnostics | O (S-CDR/G- | This field includes a more detailed technical reason for the |
| | CDR) | release of the connection and may contain one of the |
| | | following: a MAP error from GSM 09.02; or a Cause from |
| | | GSM 04.08. The diagnostics may also be extended to |
| | | include manufacturer and network specific information. |
| | | 098i/8h. |
| Record | C (S-CDR/G- | This field contains a running sequence number employed |
| Sequence | CDR) | to link the partial records generated in the SGSN/GGSN |
| Number | | for a particular PDP context (characterized with same the |
| | | Charging ID and GGSN address pair). In the S-CDR, the |
| | | sequence number is always started from one after inter- |
| | | SGSN routing area update (see field “SGSN change”). The |
| | | Record Sequence Number is missing if the record is the |
| | | only one produced in the SGSN/GGSN for the PDP |
| | | context (e.g. inter-SGSN routing area update can result to |
| | | two S-CDRs without sequence number and field “SGSN |
| | | update” present in the second record). |
| Node ID | O (S-CDR/G- | This field contains an optional operator configurable |
| | CDR) | identifier string for the node which generated the CDR. |
| Record | O (S-CDR/G- | The field enables network operators and/or manufacturers |
| Extensions | CDR) | to add their own extensions to the standard record |
| | | definitions. This field contains a set of “management |
| | | extensions” as defined in CCITT X.721. |
| Local Record | O (S-CDR/G- | This field includes a unique record number created by this |
| Sequence | CDR) | node. The number is allocated sequentially including all |
| Number | | CDR types. The number is unique within one node, which |
| | | is identified either by field Node ID or by record dependent |
| | | node address (SGSN address, GGSN address, Recording |
| | | Entity). The field can be used to identify missing records |
| | | in post processing system. |
| Access Point | M (S-CDR) | This field contains the logical APN used to determine the |
| Name OI | | actual connected access point. The APN is comprised of a |
| | | mandatory network identifier and an optional operator |
| | | identifier (this field is the operator identifier). APN can |
| | | also be a wildcard, in which case SGSN selects the access |
| | | point address. (see GSM 09.60 and GSM 03.60 for more |
| | | information about APN format and access point decision |
| | | rules.) The APN is information from the MS or SGSN, |
| | | that may be used by the GGSN to differentiate between |
| | | accesses to different external packet data networks using |
| | | the same PDP Type. |

RADIUS Accounting Method

The accounting standard specified by the IETF is a Remote Authentication Dial-In User Server/Service (RADIUS) accounting standard defined by Request for Comment (RFC) 2866. RADIUS accounting records, like the CDR counterparts, are generated upon reaching certain triggers. In addition, a field named “User-Name” is a user identifier that links the RADIUS accounting record to a particular user. Listed below is a table with the RADIUS attributes.

TABLE 2
RADIUS Accounting Record

| RADIUS Element | Description |
|---|---|
| NAS-IP-Address | This attribute indicates the identifying IP address of the server which |
| | is requesting authentication of the user. This attribute may be present |
| | if NAS-Identifier is not present. This attribute is configurable at the |
| | WSP. |
| NAS-Port-Type | This attribute indicates the type of the physical port of the NAS which |
| | is authenticating the user. It is only used in Access-Request packets. |
| | The value of the NAS-Port-Type is 19 to represent 802.11. |
| User-Name | This attribute indicates the name of the user to be authenticated. This |
| | is the user credential collected from the web login page. |
| Framed-IP-Address | This attribute indicates the IP address assigned to the user. |
| Acct-Session-ID | This attribute is a unique Accounting ID to make it easy to match start |
| | and stop records in a log file. The start, stop, and interim records for a |
| | given session have the same Acct-Session-Id. An Accounting- |
| | Request message has an Acct-Session-Id. This attribute is generated |
| | by the WSP when it sends Accounting Request (Acct-Status- |
| | Type = Start) message. |
| Acct-Status-Type | This attribute indicates whether this Accounting Request marks the |
| | beginning of the user service (Start), interim (Interim), or the end |
| | (Stop). The WSP supports the following values: Start; Stop; and |
| | Interim. |
| Acct-Terminate- | This attribute indicates how the session was terminated, and can only |
| Cause | be present in Accounting-Request records where the Acct-Status-Type |
| | is set to Stop. The WSP supports the following values: Session |
| | Timeout (5); User Request (1); Lost Service (3); Lost Carrier (2); and |
| | NAS Reboot (11). ‘Session Timeout’ indicates that the expiry of |
| | Session-Timeout values received in Accounting Request (Acct-Status- |
| | Type = Stop). ‘User Request’ indicates the user has logged out. ‘Lost |
| | Service’ indicates there was a problem communicating with the |
| | RADIUS server or RADIUS accounting server. ‘Lost Carrier’ |
| | indicates that the server is no longer able to communicate with the |
| | subscriber. ‘NAS Reboot’ indicates that the server has encountered a |
| | communication problem with internal software modules. |
| Event-Timestamp | This attribute is included in an Accounting Request message to record |
| | the time that this event occurred on the NAS, in seconds since Jan. |
| | 1, 1970 00:00 UTC. |
| Acct-Input-Octets | This attribute indicates how many octets have been received from the |
| | port over the course of this service being provided, and is sent in |
| | Accounting-Request records where the Acct-Status-Type is set to Stop |
| | or Interim. |
| Acct-Output-Octets | This attribute indicates how many octets have been sent to the port in |
| | the course of delivering this service, and is sent in Accounting- |
| | Request records where the Acct-Status-Type is set to Stop or Interim. |
| Acct-Input-Packets | This attribute indicates how many packets have been received from |
| | the port over the course of this service being provided to a Framed |
| | User, and is sent in Accounting-Request records where the Acct- |
| | Status-Type is set to Stop or Interim. |
| Acct-Output-Packets | This attribute indicates how many packets have been sent to the port |
| | in the course of delivering this service to a Framed User, and is sent in |
| | Accounting-Request records where the Acct-Status-Type is set to Stop |
| | or Interim. |
| Acct-Session-Time | This attribute indicates how many seconds the user has received |
| | service, and can only be present in Accounting-Request records where |
| | the Acct-Status-Type is set to Stop or Interim. |
| Acct-Delay-Time | This attribute indicates how many seconds the client has been trying |
| | to send the accounting message, and can be subtracted from the time |
| | of arrival on the server to find the approximate time of the event |
| | generating this Accounting Request message. (Network transit time is |
| | ignored.) It is sent in all Accounting Request message. |
| Class | This attribute is available to be sent by the server to the client in an |
| | Access Accept message, and is sent unmodified by the client to the |
| | accounting server as part of the Accounting Request message if |
| | accounting is supported. |
| VSA (Vendor | This Attribute is available to allow vendors to support their own |
| Specific Attribute) | extended Attributes not suitable for general usage. However, this |
| | attribute must not affect the operation of the RADIUS protocol. |
| | Servers not equipped to interpret the vendor-specific information sent |
| | by a client should ignore it (although it may be reported). Clients |
| | which do not receive desired vendor-specific information should make |
| | an attempt to operate without it, although they may do so (and report |
| | they are doing so) in a degraded mode. |

The system and method of the present embodiments use RADIUS accounting records to trigger GPRS CDR generation for those WLAN users that do have a GPRS account and use RADIUS messaging. The system of the present embodiment maps the parameters generated for a RADIUS Accounting-Request to a CDR. However, the CDR generation triggers are modified.

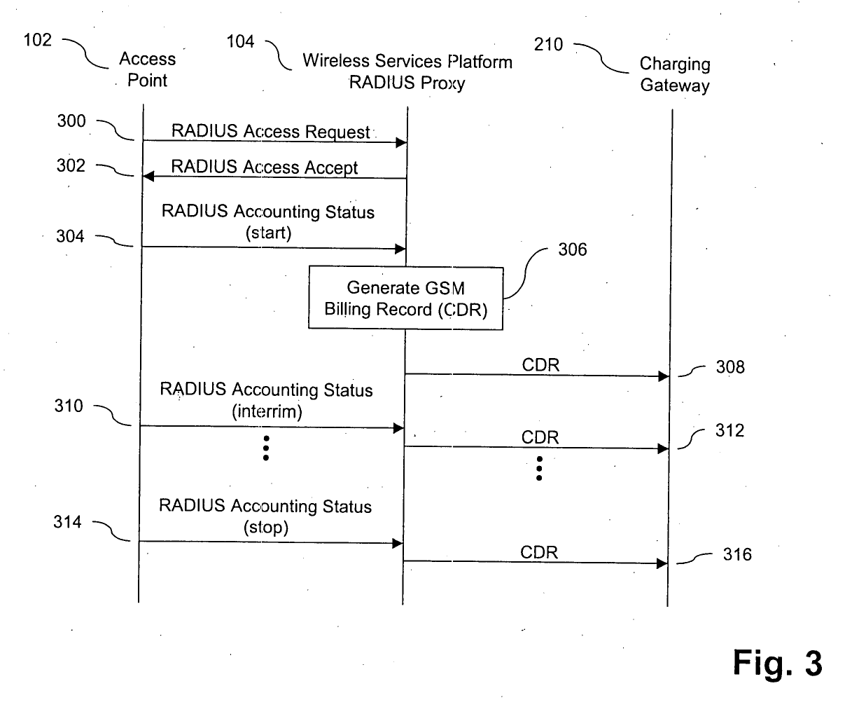

Referring to FIG. 3, one embodiment of a message dialog is shown which depicts CDR generation triggers and transmission of CDRs. The participants in the message flow are the AP 102, the WSP 104 filling the role of RADIUS Proxy (meaning the WSP is providing the services of a RADIUS Server), and a CG 210. The AP 102 may be any vendor's device which is requesting RADIUS services of the WSP 104. The message dialog begins with the AP 102 sending a RADIUS Access Request message 300 to the WSP 104. The WSP 104 responds by returning a RADIUS Access Accept message 302 to the AP 102. The AP 102 sends a RADIUS Accounting Status (start) message 304 to the WSP 104. The WSP 104 responds to this RADIUS Accounting Status (start) message 304 by generating a GSM accounting record—a Call Detail Record (CDR)—from the RADIUS accounting information contained in the RADIUS Accounting Status (start) message 304. The WSP 104 sends this CDR message 308 to the CG 210. The WSP may be configured to periodically send additional CDRs on to the CG 210 during the course of the association between the AP 102 and the WSP 104. At some later time the AP 102 sends a RADIUS Accounting Status (interim) message 310 to the WSP 104. The WSP 104 responds to this RADIUS Accounting Status (interim) message 310 by generating a CDR from the RADIUS accounting information contained in the RADIUS Accounting Status (interim) message 310 and sends this CDR message 312 on to the CG 210. The AP may periodically send additional RADIUS Accounting Status (interim) messages to the WSP 104, and on these events the WSP 104 will generate a CDR from the accounting information contained in these RADIUS Accounting Status (interim) message and send this CDR on to the CG 210. At the end of the association between the AP 102 and the WSP 104, the AP 102 sends a RADIUS Accounting Status (stop) message 314 to the WSP 104. The WSP 104 responds to this RADIUS Accounting Status (stop) message 314 by generating a CDR from the RADIUS accounting information contained in the RADIUS Accounting Status (stop) message 314 and sends this CDR message 316 on to the CG 210.

In addition, in order to convert the RADIUS messages into the GPRS CDR format to form a combined RADIUS/GPRS CDR, a parameter mapping is used by the present invention. In this embodiment, the CDR is generated by getting required parameters in real time and then writing them in the CDR. Some of the parameters are gathered from the RADIUS messages while others are generated internally by the WSP or read from a configuration file. The RADIUS accounting record is also generated and exists for V-IMSI users. Table 3 below shows the RADIUS elements correlation with the CDR elements.

TABLE 3
Correlation of RADIUS elements to CDR
dynamically from RADIUS Messages.

| RADIUS | | GPRS CDR | |
|---|---|---|---|
| Element | Description | Element | Description |
| Network | This attribute indicates the | N/A | N/A |
| Access | identifying IP address of the | | |
| Server | server which is requesting | | |
| (NAS)-IP- | authentication of the user. | | |
| Address | This attribute must be | | |
| | present if NAS-Identifier is | | |
| | not present. This attribute is | | |
| | configurable at the WSP. | | |
| NAS-Port- | This attribute indicates the | N/A | N/A |
| Type | type of the physical port of | | |
| | the NAS which is | | |
| | authenticating the user. It is | | |
| | only used in Access-Request | | |
| | packets. The value of the | | |
| | NAS-Port-Type is populated | | |
| | as 19 to represent 802.11. | | |
| User-Name | This attribute indicates the | Served IMSI | This fields contains the |
| | name of the user to be | | IMSI of the served party. |
| | authenticated. This is the | | The Client “served party” |
| | user credential collected | | is used to describe the |
| | from the web login page. | | mobile subscriber |
| | | | involved in the transaction |
| | | | recorded (e.g. the calling |
| | | | subscriber in case of a |
| | | | mobile initiated PDP |
| | | | context). |
| Framed-IP- | This attribute indicates the | Served PDP | This field contains the |
| Address | IP address assigned to the | Address | PDP address of the served |
| | user. | | IMSI. This is a network |
| | | | layer address (e.g. of type |
| | | | IP version 4, or IP version |
| | | | 6). |
| Acct- | This attribute is a unique | Charging ID | This field is a charging |
| Session-ID | Accounting ID to make it | | identifier which can be |
| | easy to match start and stop | | used together with GGSN |
| | records in a log file. The | | address to identify all |
| | start, stop, and interim | | records produced in the |
| | records for a given session | | SGSN(s) and the GGSN |
| | have the same Acct-Session- | | involved in a single PDP |
| | Id. An Accounting-Request | | context. Charging ID is |
| | message has an Acct- | | generated by the GGSN at |
| | Session-Id. This attribute is | | PDP context activation |
| | generated by the WSP when | | and transferred to a |
| | it sends an Accounting | | context requesting SGSN. |
| | Request (Acct-Status- | | At inter-SGSN routing |
| | Type = Start) message. | | area updates, the charging |
| | | | ID is transferred to the |
| | | | new SGSN as part of each |
| | | | active PDP context. |
| Acct- | This attribute indicates | N/A | N/A |
| Status-Type | whether this Accounting | | |
| | Request marks the beginning | | |
| | of the user service (Start), | | |
| | interim (Interim), or the end | | |
| | (Stop). The WSP supports | | |
| | the following values: Start; | | |
| | Stop; and Interim. | | |
| Acct- | This attribute indicates how | Cause for | This field contains a |
| Terminate- | the session was terminated, | Record | reason for the release of |
| Cause | and can only be present in | Closing/Diagnostic | the CDR including the |
| | Accounting-Request records | | following: normal release — |
| | where the Acct-Status-Type | | PDP context release or |
| | is set to Stop. The WSP | | GPRS detach; partial |
| | supports the following | | record generation —data |
| | values: Session Timeout (5); | | volume limit, time |
| | User Request (1); Lost | | (duration) limit, SGSN |
| | Service (3); Lost Carrier (2); | | change of maximum |
| | and NAS Reboot (11). | | number of changes in |
| | ‘Session Timeout’ indicates | | charging conditions; |
| | that the expiry of Session- | | abnormal termination |
| | Timeout values received in | | (PDP or MM context); |
| | Accounting Request (Acct- | | and management |
| | Status-Type = Stop). ‘User | | intervention (request due |
| | Request’ indicates the user | | to O&M reasons). |
| | has logged out. ‘Lost | | A more detailed reason |
| | Service’ indicates there was | | may be found in the |
| | a problem communicating | | diagnostics field. |
| | with the RADIUS server or | | |
| | RADIUS accounting server. | | |
| | ‘Lost Carrier’ indicates that | | |
| | the server is no longer able | | |
| | to communicate with the | | |
| | subscriber. ‘NAS Reboot’ | | |
| | indicates that the server has | | |
| | encountered a | | |
| | communication problem | | |
| | with internal software | | |
| | modules. | | |
| Event- | This attribute is included in | Record | This field contains the |
| Timestamp | an Accounting Request | Opening | time stamp when the |
| | message to record the time | Time | record is opened (see |
| | that this event occurred on | | GSM 12.05 for exact |
| | the NAS, in seconds since | | format). |
| | Jan. 1, 1970 00:00 UTC. | | |
| Acct-Input- | This attribute indicates how | List of | This list includes one or |
| Octets | many octets have been | Traffic Data | more containers, which |
| | received from the port over | Volumes: | each include the following |
| | the course of this service | Data Volume | fields: Data Volume |
| | being provided, and is sent | Downlink | Uplink, Data Volume |
| | in Accounting-Request | | Downlink, Change |
| | records where the Acct- | | Condition and Time |
| | Status-Type is set to Stop or | | Stamp. Data Volume |
| | Interim. | | includes the number of |
| | | | octets transmitted during |
| | | | the use of packet data |
| | | | services. |
| Acct- | This attribute indicates how | List of | This list includes one or |
| Output- | many octets have been sent | Traffic Data | more containers, which |
| Octets | to the port in the course of | Volumes: | each include the following |
| | delivering this service, and | Data Volume | fields: Data Volume |
| | is sent in Accounting- | Uplink | Uplink, Data Volume |
| | Request records where the | | Downlink, Change |
| | Acct-Status-Type is set to | | Condition and Time |
| | Stop or Interim. | | Stamp. Data Volume |
| | | | includes the number of |
| | | | octets transmitted during |
| | | | the use of packet data |
| | | | services. |
| Acct-Input- | This attribute indicates how | N/A | N/A |
| Packets | many packets have been | | |
| | received from the port over | | |
| | the course of this service | | |
| | being provided to a Framed | | |
| | User, and is sent in | | |
| | Accounting-Request records | | |
| | where the Acct-Status-Type | | |
| | is set to Stop or Interim. | | |
| Acct- | This attribute indicates how | N/A | N/A |
| Output- | many packets have been sent | | |
| Packets | to the port in the course of | | |
| | delivering this service to a | | |
| | Framed User, and is sent in | | |
| | Accounting-Request records | | |
| | where the Acct-Status-Type | | |
| | is set to Stop or Interim. | | |
| Acct- | This attribute indicates how | Duration | This field contains the |
| Session- | many seconds the user has | | relevant duration in |
| Time | received service for, and can | | seconds for PDP contexts |
| | only be present in | | (S-CDR, G-CDR). For |
| | Accounting-Request records | | partial records, this is the |
| | where the Acct-Status-Type | | duration of the individual |
| | is set to Stop or Interim. | | partial record and not the |
| | | | cumulative duration. |
| Acct-Delay- | This attribute indicates how | N/A | N/A |
| Time | many seconds the client has | | |
| | been trying to send the | | |
| | accounting message, and can | | |
| | be subtracted from the time | | |
| | of arrival on the server to | | |
| | find the approximate time of | | |
| | the event generating this | | |
| | Accounting Request | | |
| | message. (Network transit | | |
| | time is ignored.) It is sent in | | |
| | all Accounting Request | | |
| | message. | | |
| VSA | This Attribute is available to | N/A | N/A |
| | allow vendors to support | | |
| | their own extended | | |
| | Attributes not suitable for | | |
| | general usage. However, | | |
| | this attribute must not affect | | |
| | the operation of the | | |
| | RADIUS protocol. Servers | | |
| | not equipped to interpret the | | |
| | vendor-specific information | | |
| | sent by a client ignore it | | |
| | (although it may be | | |
| | reported). Clients which do | | |
| | not receive desired vendor- | | |
| | specific information should | | |
| | make an attempt to operate | | |
| | without it, although they | | |
| | may do so (and report they | | |
| | are doing so) in a degraded | | |
| | mode. | | |
| Class | This attribute is available to | N/A | N/A |
| | be sent by the server to the | | |
| | client in an Access Accept | | |
| | message, and SHOULD be | | |
| | sent unmodified by the client | | |
| | to the accounting server as | | |
| | part of the Accounting | | |
| | Request message if | | |
| | accounting is supported. | | |

The parameters that the Access Point generates internally or read from the configuration file are listed below in Table 4 along with the source information.

TABLE 4
Source of the CDR elements that cannot be
derived from RADIUS messages

| | Presence | |
|---|---|---|
| | M = Mandatory | |
| | C = Conditional | |
| Field | O = Optional | Description |
| Record | M (S-CDR/G-CDR) | The field identifies the type of the record e.g. S-CDR, |
| Type | | G-CDR, M-CDR, S-SMO-CDR and S-SMT-CDR. |
| GGSN | M (S-CDR/G-CDR) | The IP address of the GGSN used. |
| Address | | |
| SGSN | M (S-CDR/G-CDR) | The IP address of the SGSN. |
| Address | | |
| Routing | | Routing Area at the time of the record creation. |
| Area | | |
| Local Area | O (S-CDR) | Location area code at the time of the record creation. |
| Code | | |
| Cell | O (S-CDR) | Cell ID at the time of the record creation. |
| Identity | | |
| GGSN | M (S-CDR) | The IP address of the GGSN currently used. The |
| Address | | GGSN address is always the same for an activated |
| Used | | PDP. |
| Access | M (S-CDR/G-CDR) | This field contains the logical APN used to determine |
| Point | | the actual connected access point. APN comprises of |
| NameNI | | mandatory network identifier and optional operator |
| | | identifier (This field is the network identifier). APN |
| | | can also be a wildcard, in which case SGSN selects |
| | | the access point address. See GSM 09.60 and GSM |
| | | 03.60 for more information about APN format and |
| | | access point decision rules. The APN is information |
| | | from the MS or SGSN, that may be used by the |
| | | GGSN to differentiate between accesses to different |
| | | external packet data networks using the same PDP |
| | | Type. |
| APN | O (S-CDR/G-CDR) | This field indicates how the SGSN selected the APN |
| Selection | | to be used. The values and their meaning are as |
| Mode | | specified in GSM 09.60 clause 7.9 ‘Information |
| | | elements’. |
| PDP Type | M (S-CDR/G-CDR) | This field defines the PDP type, e.g. X.25, IP, PPP, or |
| | | IHOSS:OSP (see GSM 09.60 for exact format). |
| Dynamic | C (G-CDR) | This field indicates that PDP address has been |
| Address | | dynamically allocated for that particular PDP context. |
| Flag | | Field is missing if address is static (e.g. part of PDP |
| | | context subscription). Dynamic address allocation |
| | | might be relevant for charging (e.g. the duration of |
| | | PDP context as one resource offered and possibly |
| | | owned by network operator). |
| Node ID | O (S-CDR/G-CDR) | This field contains an optional operator configurable |
| | | identifier string for the node which generated the |
| | | CDR. |
| Local | O (S-CDR/G-CDR) | This field includes a unique record number created by |
| Record | | this node. The number is allocated sequentially |
| Sequence | | including all CDR types. The number is unique |
| Number | | within one node, which is identified either by field |
| | | Node ID or by record dependent node address (SGSN |
| | | address, GGSN address, Recording Entity). The field |
| | | can be used to identify missing records in a post |
| | | processing system. |
| Access | O (S-CDR) | This field contains the logical APN used to determine |
| Point Name | | the actual connected access point. APN comprises of |
| OI | | mandatory network identifier and optional operator |
| | | identifier (this field is the operator identifier). APN |
| | | can also be a wildcard, in which case SGSN selects |
| | | the access point address. See GSM 09.60 and GSM |
| | | 03.60 for more information about APN format and |
| | | access point decision rules. The APN is information |
| | | from the MS or SGSN, that may be used by the GGSN |
| | | to differentiate between accesses to different external |
| | | packet data networks using the same PDP Type. |
| Record | C (S-CDR/G-CDR) | This field contains a running sequence number |
| Sequence | | employed to link the partial records generated in the |
| Number | | SGSN/GGSN for a particular PDP context |
| | | (characterized with same the Charging ID and GGSN |
| | | address pair). In the S-CDR, the sequence number is |
| | | always started from one after inter-SGSN routing area |
| | | update, see field “SGSN change”. The Record |
| | | Sequence Number is missing if the record is the only |
| | | one produced in the SGSN/GGSN for the PDP context |
| | | (e.g. inter-SGSN routing area update can result to two |
| | | S-CDRs without sequence number and field “SGSN |
| | | update” present in the second record). |

Using both tables 3 and 4, the system of the present embodiments creates the new combined RADIUS/GPRS CDRs for the SIM users that utilize the RADIUS accounting and that also conform with the GPRS accounting format.

It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. A system for providing accounting for a wireless network, the system including:
an access point connectable to a mobile client;
a wireless integrated node connected to the access point and configured for providing and mapping between two different communication protocols; and
a link for connecting the wireless integrated node to a charging gateway and further to an accounting system, wherein the accounting system provides a bill for usage of the wireless network by the mobile client;
wherein the first communication protocol is of a format required by the wireless network and the second communication protocol is of a format required by the accounting system.

2. The system of claim 1 wherein the wireless integrated node includes means for generating a call detail record for use with the second communication protocol.

3. The system of claim 2 wherein the generating means maps RADIUS elements to the call detail record.

4. The system of claim 3 wherein the generation means is triggered by receiving a RADIUS Accounting Status (start) message at the wireless integrated node.

5. The system of claim 3 wherein the generation means is triggered by receiving a RADIUS Accounting Status (interim) message at the wireless integrated node.

6. The system of claim 3 wherein the generation means is triggered by receiving a RADIUS Accounting Status (stop) message at the wireless integrated node.

7. A method for generating call detail records in a format used with a mobile network for a client having an account with the mobile network and using a wireless local area network, the method comprising:
receiving a RADIUS start message from an access point;
generating a first Call Detail Record (CDR) from accounting information contained in the RADIUS start message; and
sending the first CDR message to a charging gateway associated with the mobile network.

8. The method of claim 7 wherein the mobile network is a GPRS network and the charging gateway is capable of forwarding the first CDR to an accounting system of the GPRS network.

9. The method of claim 7 further comprising:
periodically sending additional CDRs to the charging gateway during the course of the association with the access point.

10. The method of claim 7 further comprising:
receiving a RADIUS interim message from the access point;
generating a second CDR from accounting information contained in the RADIUS interim message;
sending the second CDR to the charging gateway.

11. The method of claim 10 further comprising:
continually receiving additional RADIUS interim messages;
generating additional CDRs from accounting information contained in the additional RADIUS interim messages; and
sending the additional CDRs to the charging gateway.

12. The method of claim 7 further comprising:
receiving a RADIUS stop message from the access point;
generating a stop CDR from accounting information contained in the RADIUS stop message; and
sending the stop CDR message to the charging gateway.

13. The method of claim 7 wherein the step of generating the first CDR includes:
obtaining some parameters for the first CDR from the account information contained in the RADIUS start message in real time; and
internally generating other parameters for the first CDR from a configuration file.

14. An authentication server comprising:
a first link connected to an authenticator associated with a Wireless Local Area Network (WLAN);
a second link connected to a gateway associated with a mobile network; and
a mapping system including instruction for receiving one or more first messages from the authenticator, the first messages being of a first type associated with the WLAN but not the mobile network; generating a first group of one or more call detail records from the received first messages, the call detail records being of a second type associated with the mobile network; and sending the first group of call detail records to the gateway.

15. The authentication server of claim 14 wherein the one or more first messages are associated with a client of the WLAN and the mapping system further comprises instructions for periodically sending additional call detail records to the charging gateway while the client is using the WLAN.

16. The authentication server of claim 14 wherein the mapping system further comprises instructions for receiving one or more second messages of the first type from the access point; generating a second group of one or more CDRs from accounting information contained in the one or more second messages; and sending the second group of one or more CDRs to the charging gateway.

17. The authentication server of claim 16 wherein the mapping system further comprises instructions for receiving one or more third messages of the first type from the access point; generating a third group of one or more CDRs from accounting information contained in the one or more third messages; and sending the third group of one or more CDRs to the charging gateway.

18. The authentication server of claim 14 whereby the charging gateway is configured for forwarding the first group of one or more of the CDRs to an accounting system of the mobile network.

19. The authentication server of claim 14 further comprising a configuration file and wherein the instructions for generating a first group of one or more call detail records includes instructions for obtaining some parameters from the account information contained in the one or more first messages in real time and instruction for internally generating other parameters from the configuration file.

20. The authentication server of claim 14 wherein the mobile network is a packet data network.
